(19) United States
(12) Patent Application Publication
(10) Pub. No.: US 2019/0077964 A1
(43) Pub. Date: Mar. 14, 2019

(54) MINERALS HAVING MODIFIED SURFACE PROPERTIES

(71) Applicant: Imerys USA, Inc., Roswell, GA (US)

(72) Inventors: Parvin GOLBAYANI, Johns Creek, GA (US); Douglas WICKS, Johns Creek, GA (US); Eric DRIANCOURT, Versailles (FR); David STEWART, Alpharetta, GA (US)

(21) Appl. No.: 16/085,088

(22) PCT Filed: Mar. 15, 2017
(86) PCT No.: PCT/US17/22466

§ 371 Date: Sep. 14, 2018

(30) Foreign Application Priority Data
Mar. 15, 2016 (EP) 16305284.8

(51) Int. Cl. C09C 3/06; C01F 11/18

(52) U.S. Cl. CPC C09C 3/063; C09C 1/42; C01P 2006/60; C01F 11/18

(57) ABSTRACT

Materials comprising minerals having modified surface properties, related methods, and their use in products. Materials for use in products may comprise a mineral and a carbonate, such as a precipitated calcium carbonate. Decorating the mineral with the precipitated calcium carbonate may modify a surface property of the mineral, such as, for example, absorptivity, reactivity, or fluorescence.

### CLAIM FOR PRIORITY

This application claims the benefit of priority from European Patent Application No. 16305284.8, filed Mar. 15, 2016, the contents of which are incorporated herein by reference.

### DESCRIPTION

### Field

The present disclosure relates to compositions and related methods for minerals having modified surface properties and their use in products.

### Background

In the manufacture of products, it may be desirable to modify the properties of an element, compound, or active ingredient. For example, it may be desirable to modify the surface characteristics and composition of a material. Modifying the surface of a material to control its absorbent properties, for example in a material in a scrubber on a coal fired power plant, may also be desirable. As another example, it may be desirable to modify the reactive properties of a material in order to control the rate of its decomposition in an environment, for example in the degradation of a plastic or polymer in air or in a landfill. Methods of decorating a mineral with, for example, fluorescent material may also be desirable.

As these examples illustrate, it would be desirable to provide alternative compositions and related methods for modifying the surface of a material to modify attributes of elements, compounds, and active ingredients used in a variety of industries.

### SUMMARY

The present disclosure relates to a mineral that may be decorated with a precipitated metal carbonate, such as for example a precipitated alkaline earth metal carbonate, such as for example calcium carbonate. The mineral may, for example, comprise one or more of hematite, diatomaceous earth, aluminosilicate, feldspar, palygorskite, nepheline syenite, silica, attapulgite clay, talc, an alkali earth metal carbonate, kaolin, bentonite, calcium carbonate, barium carbonate, and magnesium carbonate. Calcium carbonate may comprise one or more of precipitated calcium carbonate, ground calcium carbonate, dolomite, limestone, chalk, and marble.

Decorated may mean for example that the precipitated alkaline earth metal carbonate is physisorbed or chemisorbed to at least some fraction of the mineral surface. In one alternative, the mineral may be encapsulated by the precipitated calcium carbonate. Encapsulated may mean, for example, that the precipitated calcium carbonate covers at least a majority or possibly all of the mineral's surface. For example, the encapsulation may comprise a core/shell structure.

The precipitated alkaline earth metal carbonate may further comprise a metal element. The metal element may comprise one or more of Eu, Y, Sm, La, Ce, Pr, Nd, Pm, Gd, Tb, Dy, Ho, Er, Tm, Yb, Sc, Ti, V, Cr, Mn Fe, Co, Ni, Cu, Zn, Zr, Nb, Mo, Tc, Ru, Rh, Pd, Ag, Cd, Lu, Hf, Ta, W, Re, Os, Ir, Pt, Au, and Hg. The precipitated alkaline earth metal carbonate material may be fluorescent, and may for example fluoresce under UV irradiation, electromagnetic radiation having a wavelength in the range of 200-400 nm, or electromagnetic radiation having a wavelength in the range of 225-300 nm.

Materials comprising a precipitated alkaline earth metal carbonate supported on a mineral are also disclosed. The precipitated alkaline earth metal carbonate may be, for example, a precipitated calcium carbonate. The precipitated calcium carbonate may comprise a surface modification, such as the addition of one or more components to the surface. For example, the surface modification may comprise a core/shell structure. The surface modification may after absorbent properties, reactive properties, fluorescent properties, or other surface properties of the material and the carbonate.

The present disclosure also relates to a process of making a material comprising a mineral and a surface-modified precipitated alkaline earth metal carbonate. The process may comprise mixing a calcium source, a mineral, and a carbonate. The calcium source may comprise an aqueous calcium solution. The aqueous calcium solution may comprise a solution of one or more of calcium chloride, calcium nitrate, calcium hydroxide, calcium sulfide, and calcium sulfate. The carbonate may comprise one or more of NaHCO₃, (NH₄)₂CO₃, Na₂CO₃, Li₂CO₃, K₂CO₃, KHCO₃, NH₄HCO₃, and H₂CO₃. The mineral may comprise one or more of hematite, diatomaceous earth, aluminosilicate, feldspar, palygorskite, nepheline syenite, silica, attapulgite clay, talc, an alkali earth metal carbonate, kaolin, bentonite, calcium carbonate, barium carbonate, and magnesium carbonate. Calcium carbonate may, for example, comprise precipitated calcium carbonate, ground calcium carbonate, dolomite, limestone, chalk, and marble. The aqueous calcium solution may further comprise a metal. The metal may comprise Eu, Y, Sm, La, Ce, Pr, Nd, Pm, Gd, Tb, Dy, Ho, Er, Tm, Yb, Sc, Ti, V, Cr, Mn, Fe, Co, Ni, Cu, Zn, Zr, Nb, Mo, Tc, Ru, Rh, Pd, Ag, Cd, Lu, Hf, Ta, W, Re, Os, Ir, Pt, Au, and Hg. The metal may comprise a metal salt.

Exemplary objects and advantages will be set forth in part in the description which follows, or may be learned by practice of the exemplary embodiments. It is to be understood that both the foregoing general description and the following detailed description are exemplary and explanatory only and are not restrictive of the invention, as claimed.

### DESCRIPTION

The present disclosure relates to materials comprising surface-modified precipitated alkaline earth metal carbonate. The surface modification may comprise the addition of one or more components to the surface. The surface modification may alter absorbent or reactive properties of the precipitated alkaline earth metal carbonate. For example, the surface modification may affect how quickly the precipitated alkaline earth metal carbonate dissolves or reacts with the environment, for example by changing the resistivity or sensitivity to acid. The acid resistance of the underlying material may also be increased through surface modification of the calcium carbonate.

In some embodiments, the absorbent properties of the material may be modified. For example, the material's absorbent properties may be modified to affect the rate of absorption of organic or biological components, for example for use in food, hygiene and health applications. Exemplary organic components may comprise oils, inks, proteins, dead cells, polymers, and toxins. As one example, the material may be modified to absorb residual mineral oil from ink.

In some embodiments, the absorbent properties of the material may be modified to affect the rate of absorption of gases, for example for use in pollution control applications. The gases may comprise nitrogen oxides, sulfur oxides, carbon monoxide, carbon dioxide, flue gases, or other combustion byproducts. For example, the material may act as a gas absorbent for coal-fired power-plant exhaust, or in another example for use in personal protective equipment (PPE), or in another example to improve handling of carbon black absorbent. In some embodiments the material is at least partially calcined, for example to desiccate.

In some embodiments the absorbent properties of the material may be modified for use in filtration or purification. For example, the material may be used for active filtration via porosity control. The material may be used to filter or purify water, for example acting a substitute for an activated carbon or charcoal or sugar:control charcoal filter. In some embodiments, the absorbent properties may also be modified for use to filter or purify waste, example the material may be used to purify waste, such as agricultural waste or chicken-coop waste.

In some embodiments, the material may comprise surface modification by addition of a catalyst.

In some embodiments, the surface of the material may be modified to accelerate the decomposition or degradation of polymers, such as plastics. For example, the material may accelerate decomposition of one or more of high density polyethylene, low density polyethylene, polyethylene terephthalate, polyvinyl chloride, polypropylene, polystyrene, polyamide, and acrylonitrile butadiene styrene. This surface property maybe used to aid in recycling.

In some embodiments, the material may have a surface modification comprising a polymer layer, for example to reduce or eliminate the need for a compounding process. Relatively thick polymer layers may be used.

In some embodiments, the material may be modified for use in electrical applications. For example, the material may modified with a conductive or semi-conductive material, such as TiO₂, SiO₂, SnO, ZnO, GaAs, Ge, or a photosensitive dye. In some embodiments, the electrical application may be use in a semiconductor device, for example a transistor, diode, light emitting diode, organic light emitting diode, or photovoltaic cell.

In some embodiments, the material may be modified by surface addition of a resin or rosin, for example terpenic resin, for use in for example inks, adhesives, rubber, flotation devices, waves, paints, varnishes, food, and cosmetics.

In some embodiments, the material may be modified to affect gelling properties, for example to cause gelation at a different temperature for example for use to stop dewatering in paper applications.

In some embodiments, the material may be modified by addition of an indicator. For example a fluorescent material may be used as an expiration indicator or an environmental monitor.

In some embodiments, the material may comprise one or more polymorphs of precipitated calcium carbonate, for example vaterite and calcite. In some embodiments the different polymorphs (e.g., vaterite, calcite, aragonite, or amorphous) may be used for one or more different timed releases, for example to have a fast release from vaterite and a slow release from calcite. In some embodiments the transition from vaterite to calcite will encapsulate or reject a surface additive.

In some embodiments, the surface modification may comprise the addition of linoleic acid or stearin. These modifications may find use, for example, in hydrophobic applications or where it is desirable to improve compatibility with an organic component or phase. Linoleic acid or stearin may act as a cross-linking agent or to functionalize with a fluorescent material. These compounds also may, in some instances, assist in reticulation.

In some embodiments, a platy template, for example platy carbonate, is used to precipitate precipitated calcium carbonate.

In some embodiments, the surface is modified by a colorant for example TiO₂, for example to improve opacity, for example for use in a paint.

In some embodiments, the material may comprise a surface-modified precipitated calcium carbonate supported on a mineral. The mineral may comprise, for example, hematite, diatomaceous earth, aluminosilicate, feldspar, palygorskite, nepheline syenite, silica, attapulgite clay, talc, an alkali earth metal carbonate, kaolin, bentonite, calcium carbonate, barium carbonate, and magnesium carbonate. Calcium carbonate may comprise precipitated calcium carbonate, ground calcium carbonate, dolomite, limestone, chalk, and marble.

In some embodiments, the mineral may be decorated with precipitated calcium carbonate. Precipitated calcium carbonate may be, for example, physisorbed or chemisorbed to at least some fraction of the mineral surface. Alternatively, the mineral may be decorated by encapsulated it with precipitated calcium carbonate. The precipitated calcium carbonate may cover a majority of the mineral's surface of the mineral. In some cases, the entire surface of the mineral may be covered by the precipitated calcium carbonate.

In some embodiments, the precipitated calcium carbonate used to decorate the mineral may further comprise a metal element, such as, for example, Eu, Y, Sm, La, Ce, Pr, Nd, Pm, Gd, Tb, Dy, Ho, Er, Tm, Yb, So, Ti, V, Cr, Mn, Fe, Co, Ni, Cu, Zn, Zr, Nb, Mo, Tc, Ru, Rh, Pd, Ag, Cd, Lu, Hf, Ta, W, Re, Os, Ir, Pt, Au, and Hg.

The decorated mineral may fluoresce under UV irradiation or electromagnetic radiation. For example, the decorated mineral may fluoresce when exposed to UV irradiation or electromagnetic radiation having a wavelength in the range of 225-300 nm or in the range of 200-400 nm.

Minerals decorated with fluorescent precipitated alkaline earth metal carbonate may be used, for example, in paper, packaging, or security inks. For example, the decorated mineral may be used to place an “invisible” bar code on a package—the bar code would only appear when exposed to UV irradiation or electromagnetic radiation within a particular wavelength. Pharmaceutical, cosmetic, and health & beauty applications may also exist for minerals decorated with fluorescent precipitated calcium carbonate.

In some embodiments the surface may be modified for use in hygiene applications, for example for use in a dry hair shampoo where oil is absorbed. Further, the surface may be modified to absorb dead skin cells for use in cosmetics or hygienic applications. In some embodiments the surface may absorb proteins for adhesive purposes.

In some embodiments the surface may be modified to include with high molecular weight components, for example to improve flexibility, or for example to promote self-binding.

Exemplary processes for making a material comprising a mineral and a surface-modified precipitated calcium carbonate are also disclosed. These processes may, for example, comprise mixing a calcium source, a mineral, and a carbonate. Calcium sources may include, for example, an aqueous calcium solution, for example a solution of one or more of calcium chloride, calcium nitrate, calcium hydroxide, calcium sulfide, and calcium sulfate. Exemplary minerals may include hematite, diatomaceous earth, aluminosilicate, feldspar, palygorskite, nepheline syenite, silica, attapulgite clay, talc, an alkali earth metal carbonate, kaolin, bentonite, calcium carbonate, barium carbonate, and magnesium carbonate. Calcium carbonate may, for example, comprise precipitated calcium carbonate, ground calcium carbonate, dolomite, limestone, chalk, and marble. Exemplary carbonates may include NaHCO₃, (NH₄)₂CO₃, Na₂CO₃, Li₂CO₃, K₂CO₃, KHCO₃, NH₄HCO₃, and H₂CO₃. In some embodiments the aqueous solution may further comprise a metal, such as, for example, Eu, Y, Sm, La, Ce, Pr, Nd, Pm, Gd, Tb, Dy, Ho, Er, Tm, Yb, Sc, Ti, V, Cr, Mn, Fe, Co, Ni, Cu, Zn, Zr, Nb, Mo, Tc, Ru, Rh, Pd, Ag, Cd, Lu, Hf, Ta, W, Re, Os, Ir, Pt, Au, or Hg. Metal salts thereof may also be included.

As used herein, the terms “fluorescence”, “fluoresce”, or “fluorescent response” refer to the emission of electromagnetic energy (e.g., light) by a substance that has absorbed light or other electromagnetic energy or radiation. The emitted light has a longer wavelength, and therefore lower energy, than the absorbed radiation. However, it is meant to generally encompass irradiation at one wavelength and emission of light at a different wavelength. Examples of fluorescence that can be achieved according to the present disclosure include UV to Visible (the material emits visible light after being irradiated with UV light); UV to UV (wherein the emitted and irradiated wavelengths are different); UV to Near IR; and Visible to Near IR.

As used herein the term “UV” or “ultraviolet” light refers to Near UVA (300 nm to 400 nm); UVB (280 nm to 300 nm); and UVA (100 nm to 280 nm).

It is possible that the fluorescent response may be configured such that it is not visible to the naked eye, but detectable in the presence of natural light or ultraviolet light. For example, the material may be configured to emit the fluorescent response not when exposed to ambient or natural light, but when irradiated at a predetermined wavelength.

Embodiments consistent with the disclosure may include, for example: the following numbered paragraphs:

1. A material comprising a mineral decorated with a fluorescent precipitated alkaline earth metal carbonate.

2. The material of paragraph 1, wherein the mineral comprises one or more of the mineral comprises one or more of hematite, diatomaceous earth, aluminosilicate, feldspar, palygorskite, nepheline syenite, silica, attapulgite clay, talc, an alkali earth metal carbonate, kaolin, bentonite, calcium carbonate, barium carbonate, and magnesium carbonate.

3. The material of paragraph 1 or paragraph 2, wherein the calcium carbonate comprises one or more of precipitated calcium carbonate, ground calcium carbonate, dolomite, limestone, chalk, and marble.

4. The material of any preceding numbered paragraph, wherein the mineral is encapsulated by calcium carbonate.

5. The material of any preceding numbered paragraph, wherein the material further comprises a metal element.

6. The material of paragraph 5, wherein the metal element comprises one or more of Eu, Y, Sm, La, Ce, Pr, Nd, Pm, Gd, Tb, Dy, Ho, Er, Tm, Yb, Sc, Ti, V, Cr, Mn, Fe, Co, Ni, Cu, Zn, Zr, Nb, Mo, Tc, Ru, Rh, Pd, Ag, Cd, Lu, Hf, Ta, W, Re, Os, Ir, Pt, Au, and Hg.

7. The material of any preceding numbered paragraph, wherein the fluorescent precipitated alkaline earth metal carbonate comprises a fluorescent calcium carbonate.

8. The material of any preceding numbered paragraph, wherein the material fluoresces under irradiation with a wavelength in the range of 200-400 nm.

9. The material of any preceding numbered paragraph, wherein the material fluoresces under irradiation with a wavelength in the range of 225-300 nm.

10. A process for making a fluorescent material comprising mixing a calcium source, a mineral, and a carbonate.

11. The process of paragraph 10, wherein the calcium source is an aqueous solution.

12. The process of paragraph 11, wherein the aqueous solution comprises one or more of calcium chloride, calcium nitrate, calcium hydroxide, calcium sulfide, and calcium sulfate.

13. The process of paragraphs 10, 11 or 12, wherein the mineral material comprises one or more of ground calcium carbonate, hematite, and diatomaceous earth.

14. The process of one of paragraphs 10-13, wherein the carbonate comprises one or more of NaHCO₃, (NH₄)₂CO₃, Na₂CO₃, Li₂CO₃, K₂CO₃, KHCO₃, NH₄HCO₃, and H₂CO₃.

15. The process of one of paragraphs 11-13, wherein the aqueous solution further comprises a metal.

16. The process of paragraph 15, wherein the metal comprises one or more of Eu, Y, Sm, La, Ce, Pr, Nd, Pm, Gd, Tb, Dy, Ho, Er, Tm, Yb, Sc, Ti, V, Cr, Mn, Fe, Co, Ni, Cu, Zn, Zr, Nb, Mo, Tc, Ru, Rh, Pd, Ag, Cd, Lu, Hf, Ta, W, Re, Os, Ir, Pt, Au, and Hg.

17. The process of one of paragraphs 10-16, wherein the fluorescent material fluoresces under UV irradiation.

18. The process of one of paragraphs 10-17, wherein the fluorescent material fluoresces under irradiation with a wavelength in the range of 200-400 nm.

19. The process of one of paragraphs 10-18, wherein the fluorescent material fluoresces under irradiation with a wavelength in the range of 225-300 nm.

20. A material comprising a mineral supporting a surface-modified carbonate.

21. The material of paragraph 20, wherein the surface-modified carbonate comprises a precipitated calcium carbonate.

22. The material of paragraph 20, wherein the surface modification comprises the addition of one or more components to alter a surface property exhibited by the material.

23. The material of paragraph 22 wherein the surface property is the absorptivity of the material.

24. The material of paragraph 22 wherein the surface property is the reactivity of the material.

25. The material of paragraph 22 wherein the surface property is the fluorescence of the material.

26. A material comprising a mineral decorated with precipitated carbonate.

27. The material of paragraph 26, wherein the mineral comprises one or more of the mineral comprises one or more of hematite, diatomaceous earth, aluminosilicate, feldspar, palygorskite, nepheline syenite, silica, attapulgite clay, talc, an alkali earth metal carbonate, kaolin, bentonite, calcium carbonate, barium carbonate, and magnesium carbonate.

28. The material of paragraph 27, wherein the calcium carbonate comprises one or more of precipitated calcium carbonate, ground calcium carbonate, dolomite, limestone, chalk, and marble.

29. The material of paragraph 26, wherein the mineral is encapsulated by calcium carbonate.

30. The material of paragraph 26, wherein the material further comprises a metal element.

31. The material of paragraph 30, wherein the metal element comprises one or more of Eu, Y, Sm, La, Ce, Pr, Nd, Pm, Gd, Tb, Dy, Ho, Er, Tm, Yb, Sc, Ti, V, Cr, Mn, Fe, Co, Ni, Cu, Zn, Zr, Nb, Mo, Tc, Ru, Rh, Pd, Ag, Cd, Lu, Hf, Ta, W, Re, Os, Ir, Pt, Au, and Hg.

32. The material of paragraph 26, wherein the material fluoresces under UV irradiation.

33. The material of paragraph 32, wherein the material fluoresces under irradiation with a wavelength in the range of 200-400 nm.

34. The material of paragraph 33, wherein the material fluoresces under irradiation with a wavelength in the range of 225-300 nm.

### EXAMPLE 1

Diatomaceous earth was decorated with precipitated calcium carbonate using the following method:

First, 0.036 mol CaCl₂ in 250 mL of water was dissolved with 0.01 mol percent Eu as EuCl₂. A sample of 3.66 g diatomaceous earth was added to the mixture. After that, 0.073 mol NaHCO₃ was also added. The resulting mixture was mixed, filtered, washed, and dried 120° C. for 3 hrs.

The final product emitted red/orange fluorescence under UV (254 nm) irradiation.

Other embodiments will be apparent to those skilled in the art from consideration of the specification and practice of the exemplary embodiments disclosed herein. It is intended that the specification and examples be considered as exemplary only, with a true scope and spirit of the invention being indicated by the claims.

1. A material comprising a mineral decorated with a fluorescent precipitated alkaline earth metal carbonate.

2. The material of claim 1, wherein the mineral comprises one or more of the mineral comprises one or more of hematite, diatomaceous earth, aluminosilicate, feldspar, palygorskite, nepheline syenite, silica, attapulgite clay, talc, an alkali earth metal carbonate, kaolin, bentonite, calcium carbonate, barium carbonate, and magnesium carbonate.

3. The material of claim 2, wherein the calcium carbonate comprises one or more of precipitated calcium carbonate, ground calcium carbonate, dolomite, limestone, chalk, and marble.

4. The material of claim 1, wherein the mineral is encapsulated by calcium carbonate.

5. The material of claim 1, wherein the material further comprises a metal element.

6. The material of claim 5, wherein the metal element comprises one or more of Eu, Y, Sm, La, Ce, Pr, Nd, Pm, Gd, Tb, Dy, Ho, Er, Tm, Yb, Sc, Ti, V, Cr, Mn, Fe, Co, Ni, Cu, Zn, Zr, Nb, Mo, Tc, Ru, Rh, Pd, Ag, Cd, Lu, Hf, Ta, W, Re, Os, Ir, Pt, Au, and Hg.

7. The material of claim 1, wherein the fluorescent precipitated alkaline earth metal carbonate comprises a fluorescent calcium carbonate.

8. The material of claim 7, wherein the material fluoresces under irradiation with a wavelength in the range of 200-400 nm.

9. The material of claim 7, wherein the material fluoresces under irradiation with a wavelength in the range of 225-300 nm.

10. A process for making a fluorescent material comprising mixing a calcium source, a mineral, and a carbonate.

11. The process of claim 10, wherein the calcium source is an aqueous solution.

12. The process of claim 10, wherein the aqueous solution comprises one or more of calcium chloride, calcium nitrate, calcium hydroxide, calcium sulfide, and calcium sulfate,

13. The process of claim 10, wherein the mineral material comprises one or more of ground calcium carbonate, hematite, and diatomaceous earth.

14. The process of claim 10, wherein the carbonate comprises one or more of NaHCO₃, (NH₄)₂CO₃, Na₂CO₃, Li₂CO₃, K₂CO₃, KHCO₃, NH₄HCO₃, and H₂CO₃.

15. The process of claim 10, wherein the aqueous solution further comprises a metal.

16. The process of claim 15, wherein the metal comprises one or more of Eu, Y, Sm, La, Ce, Pr, Nd, Pm, Gd, Tb, Dy, Ho, Er, Tm, Yb, Sc, Ti, V, Cr, Mn, Fe, Co, Ni, Cu, Zn, Zr, Nb, Mo, Tc, Ru, Rh, Pd, Ag, Cd, Lu, Hf, Ta, W, Re, Os, Ir, Pt, Au, and Hg.

17. The process of claim 11, wherein the fluorescent material fluoresces under UV irradiation.

18. The process of claim 17, wherein the fluorescent material fluoresces under irradiation with a wavelength in the range of 200-400 nm.

19. The process of claim 18, wherein the fluorescent material fluoresces under irradiation with a wavelength in the range of 225-300 nm.

20. A material comprising a mineral supporting a surface-modified carbonate, wherein the surface modification comprises the addition of ane or more components to alter the absorptivity, reactivity, or fluorescence of the material.

21-25. (canceled)
